(19) United States
(12) Patent Application Publication
(10) Pub. No.: US 2009/0147192 A1
(43) Pub. Date: Jun. 11, 2009

(54) LIQUID CRYSTAL DISPLAY DEVICE AND A METHOD OF MANUFACTURING THE SAME

(75) Inventor: Koji Ishizaki, Tokyo (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/327,909

(22) Filed: Dec. 4, 2008

(30) Foreign Application Priority Data
Dec. 5, 2007 (JP) 2007-314346
Feb. 22, 2008 (JP) 2008-040968

(51) Int. Cl. G02F 1/1335

(52) U.S. Cl. 349/117

(57) ABSTRACT

Disclosed herein is a liquid crystal display device including two sheets of substrates, a liquid crystal layer sealed between the two sheets of substrates, and a retardation layer provided on the liquid crystal layer side in one of the two sheets of substrates, wherein the retardation layer has a structure in which polymerizable liquid crystal monomers are three-dimensionally cross-linked, and a retardation R(450) for a wavelength of 450 nm and a retardation R(550) for a wavelength of 550 nm fulfill a relationship of R(450)/R(550)≦1.

### CROSS REFERENCES TO RELATED APPLICATIONS

The present invention contains subject matter related to Japanese Patent Applications JP 2007-314346 and JP 2008-040968 filed in the Japan Patent Office on Dec. 5, 2007 and Feb. 22, 2008, respectively, the entire contents of which being incorporated herein by reference.

### BACKGROUND OF THE INVENTION

1. Field of the Invention

The present invention relates to a liquid crystal display device and a method of manufacturing the same, and more particularly to a liquid crystal display device in which a retardation layer for obtaining a wide view angle in color display is provided, and a method of manufacturing the same.

2. Description of the Related Art

For the purpose of improving a contrast and enhancing a view angle, a retardation layer for optical compensation is provided in a liquid crystal display device having a liquid crystal layer held between a pair of substrates. In addition, a semitransmission and semireflection type liquid crystal display device, a transmissive display region and a reflective display region are both realized within one pixel by using a retardation layer as a circularly polarizing plate. In recent years, a constitution has been proposed in which such a retardation layer is provided between substrates (that is, within a liquid crystal cell) of a liquid crystal display device to be disposed in the liquid crystal cell, thereby realizing the thinning of the liquid crystal display device and the simplification of manufacturing processes.

Here, in a color liquid crystal display device, a retardation layer having a so-called broadband property is desired for the purpose of obtaining a satisfactory view angle in a wide range of a visible light. It is necessary to select a material having a wave dispersibility (inverse dispersibility) in which a retardation increases toward long wavelengths and to make such a retardation layer of the material thus selected. A retardation layer made of polycarbonate having fluorene skeleton, for example, is disclosed as the retardation layer in which the wavelength dispersion shows the inverse dispersibility. This retardation layer is described in Japanese Patent Laid-Open No. 2005-189632.

However, such a material is not suitable for disposing the retardation layer in the liquid crystal cell. Thus, many polymer materials have a tendency to show a wavelength dispersion (forward dispersion) that the retardation becomes small toward the long wavelengths. In order to cope with such a situation, a constitution has been proposed in which the retardation layers are provided in the form of a lamination structure by utilizing that the retardation layers made of materials each having the normal dispersibility are laminated into a lamination structure, thereby obtaining a broadband property. This technique, for example, is described in Japanese Patent Laid-Open No. 2003-322857. In Japanese Patent Laid-Open No. 2003-322857, a description relating to FIG. 4 is given.

A polymerization type liquid crystal material, for example, is used as the constituent material for the retardation layer suitable for being disposed in the liquid crystal cell as described above. When the polymerization type liquid crystal material is used as the constituent material for the retardation layer, the patterning can be carried out by utilizing the lithography method. Thus, the retardation layer can be formed in a pattern in a predetermined portion (for example, a reflective display portion within the pixel) within the liquid crystal cell. In addition, with regard to the retardation layer having the lamination structure, there is disclosed an example in which a polymerizable cholesteric liquid crystal is used. This technique, for example, is described in Japanese Patent Laid-Open No. 2001-56484.

### SUMMARY OF THE INVENTION

However, in order to provide the retardation layers in the form of the lamination structure within the liquid crystal cell, the process for forming the retardation layer needs to be carried out twice. Therefore, for example, in the case of the constitution in which the retardation layer is formed in a pattern only in the reflective display portion within the pixel as in the semitransmission and semireflection type liquid crystal display device, the number of manufacturing processes is large and thus an effort is invested because two lithography processes need to be carried out in an overlap manner.

In the light of the foregoing, it is therefore desire to provide a liquid crystal display device in which a reliable retardation layer having a broadband property can be disposed in the liquid crystal cell, and a method of manufacturing the same.

In order to attain the desire described above, according to an embodiment of the present invention, there is provided a liquid crystal display device including two sheets of substrates, a liquid crystal layer sealed between the two sheets of substrates, and a retardation layer provided on the liquid crystal layer side in one of the two sheets of substrates, in which the retardation layer has a structure in which polymerizable liquid crystal monomers are three-dimensionally cross-linked, and a retardation R(450) for a wavelength of 450 nm and a retardation R(550) for a wavelength of 550 nm fulfill a relationship of R(450)/R(550)≦1.

According to another embodiment of the present invention, there is provided a method of manufacturing a liquid crystal display device including the steps of: forming a retardation layer on a first substrate; disposing a second substrate so as to face a side of a formation surface of the retardation layer on the first substrate; and filling and sealing a liquid crystal layer between the first substrate and the second substrate, the method of manufacturing a liquid crystal display device, when the retardation layer is formed, including the steps of: applying a liquid solution containing therein polymerizable liquid crystal monomers onto an orientation surface of the first substrate to form a retardation layer formation film; performing orientation processing for the retardation layer formation film; three-dimensionally cross-linking the polymerizable liquid crystal monomers contained the retardation layer formation film for which the orientation processing is performed to cure the polymerizable liquid crystal monomers; and obtaining the retardation layer in which a retardation R(450) for a wavelength of 450 nm and a retardation R(550) for a wavelength of 550 nm fulfill a relationship of R(450)/R(550)≦1.

According to still another embodiment of the present invention, there is provided a liquid crystal display device including two sheets of substrates, a liquid crystal layer sealed between the two sheets of substrates, a reflective material layer provided on a side of the liquid crystal layer in one of the two sheets of substrates, and a retardation layer formed in a pattern above the reflective material layer, in which the reflective material layer is entirely covered with the retardation layer.

With the constitution described above, the retardation layer having the inverse dispersibility is provided within the liquid crystal cell having the liquid crystal layer sealed between the two sheets of substrates so as to fulfill the above retardation conditions. For this reason, the retardation layer which corresponds to the broader wavelength band in spite of having the single layer structure is disposed in the liquid crystal cell. In addition, the retardation layer is excellent in heat resistance and chemical resistance because it has the structure in which the polymerizable liquid crystal monomers are three-dimensionally cross-linked.

As set forth hereinabove, according to an embodiment of the present invention, it is possible to realize the liquid crystal display device in which the reliable retardation layer which includes the broadband property in spite of having the single layer structure, and which is excellent in heat resistance and in chemical resistance is disposed in the liquid crystal cell.

### BRIEF DESCRIPTION OF THE DRAWINGS

FIG. 1 is a graph explaining a wavelength dispersibility of a retardation layer;

FIG. 2 is a flow chart showing a first example of a procedure for forming the retardation layer;

FIG. 3 is a flow chart showing a second example of a procedure for forming the retardation layer;

FIG. 4 is a cross sectional view showing a structure of a transmission type liquid crystal display device according to a first embodiment of the present invention;

FIG. 5 is a cross sectional view showing a structure of a transmission type liquid crystal display device according to a second embodiment of the present invention;

FIG. 6 is a cross sectional view showing a structure of a reflection type liquid crystal display device according to a third embodiment of the present invention;

FIG. 7 is a cross sectional view showing a structure of a reflection type liquid crystal display device according to a fourth embodiment of the present invention;

FIG. 8 is a cross sectional view showing a structure of a semitransmission and semireflection type liquid crystal display device according to a fifth embodiment of the present invention;

FIG. 9 is a cross sectional view showing a structure of a main portion for one pixel of the semitransmission and semireflection type liquid crystal display device according to the fifth embodiment of the present invention;

FIG. 10 is a cross sectional view showing a structure of a semitransmission and semireflection type liquid crystal display device according to a sixth embodiment of the present invention;

FIG. 11 is a cross sectional view showing a structure of a main portion for one pixel of the semitransmission and semireflection type liquid crystal display device according to the sixth embodiment of the present invention;

FIG. 12 is a circuit diagram, partly in block, showing an example of a circuit configuration of the liquid crystal display device to which an embodiment of the present invention is applied;

FIG. 13 is a perspective view of a television set as an example of application to which an embodiment of the present invention is applied;

FIGS. 14A and 14B are respectively a perspective view of a digital camera as another example of application, when viewed from a front side, to which an embodiment of the present invention is applied, and a perspective view of the digital camera as the another example of application, when viewed from a back side, to which an embodiment of the present invention is applied;

FIG. 15 is a perspective view showing a notebook-size personal computer as still another example of application to which an embodiment of the present invention is applied;

FIG. 16 is a perspective view showing a video camera, as yet another example of application, to which an embodiment of the present invention is applied; and

FIGS. 17A to 17G are views showing a mobile terminal equipment such as mobile phone to which an embodiment of the present invention is applied, FIG. 17A is a front view of the mobile phone in an open position, FIG. 17B is a side view thereof, FIG. 17C is a front view thereof in a closed position, FIG. 17D is a left side view thereof, FIG. 17E is a right side view thereof, FIG. 17F is a top view thereof, and FIG. 17G is a bottom view thereof.

### DETAILED DESCRIPTION OF THE PREFERREED EMBODIMENTS

The preferred embodiments of the present invention will be described in detail hereinafter with reference to the accompanying drawings. Firstly, the description will be given in the order of a retardation layer provided in a liquid crystal display device according to any of the first to sixth embodiments of the present invention, a method of forming the retardation layer, and structures of the liquid crystal display devices, according to the first to sixth embodiments of the present invention, each using the retardation layer.

### <Retardation Layer>

The first feature of the retardation layer used in each of the liquid crystal display devices of the first to sixth embodiments of the present invention is that polymerizable liquid crystal monomers are three-dimensionally cross-linked. In addition, the second feature of the retardation layer used therein is that a retardation R(450) for a wavelength of 450 nm, and a retardation R(550) for a wavelength of 550 nm fulfill a relationship of R(450)/R(550)≦1 and thus the retardation layer does not have a normal dispersibility, but preferably has an inverse dispersibility.

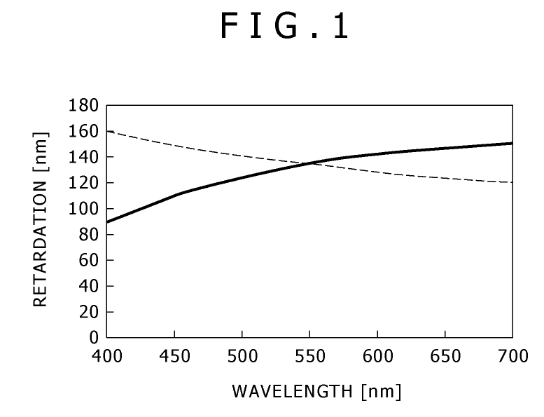

FIG. 1 shows a graph of a retardation vs. a wavelength. As shown in the graph, the retardation layer used in each of the first to sixth embodiments of the present invention does not have the normal dispersibility as represented by a broken line in the graph, but preferably has the inverse dispersibility as represented by a solid line in the graph. In this case, in the normal dispersibility, the retardation becomes lower in the long wavelength band. Also, in the inverse dispersibility, the retardation becomes higher in the long wavelength band.

The retardation layer as described above is made of a so-called polymerizable liquid crystal monomers, for example, of Compounds (1) to (5). Thus, the retardation layer concerned has a structure in which the polymerizable liquid crystal monomers are three-dimensionally cross-linked in a state in which a radiation cure liquid crystal (nematic liquid crystal) is oriented singularly, or two or more kinds of radiation cure liquid crystals are oriented as may be necessary.

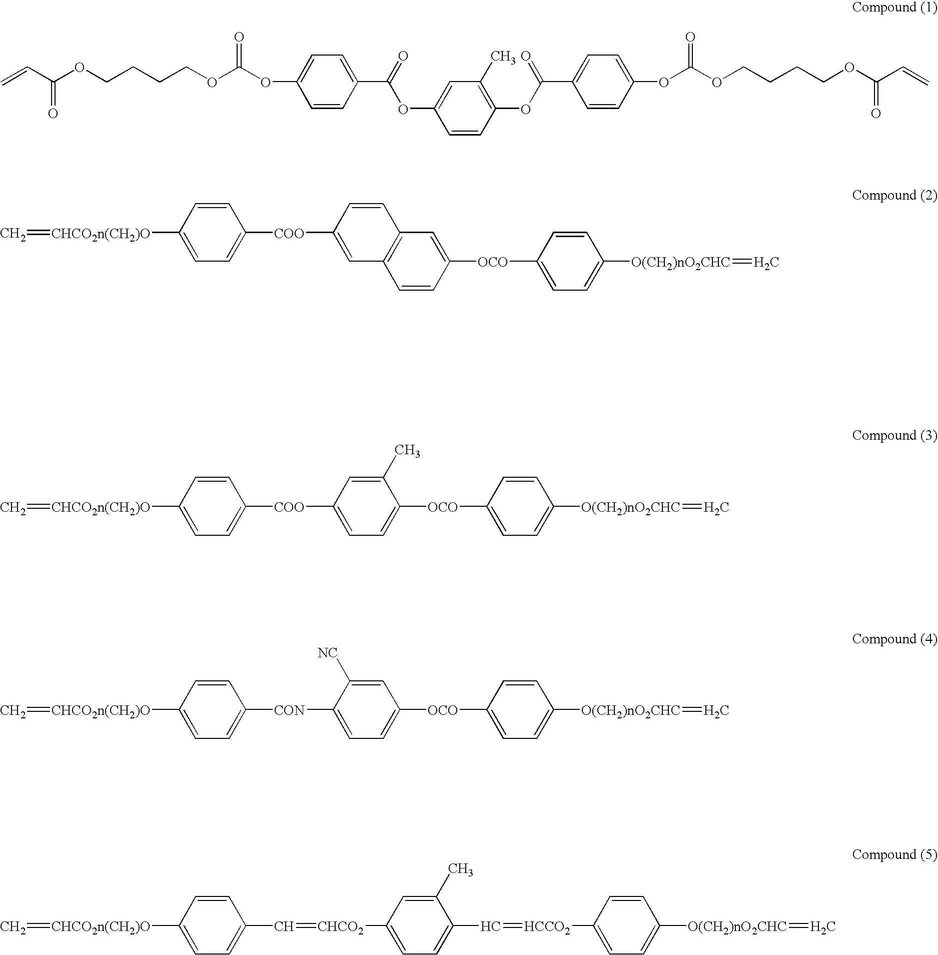

### <Method of Forming Retardation Layer—1>

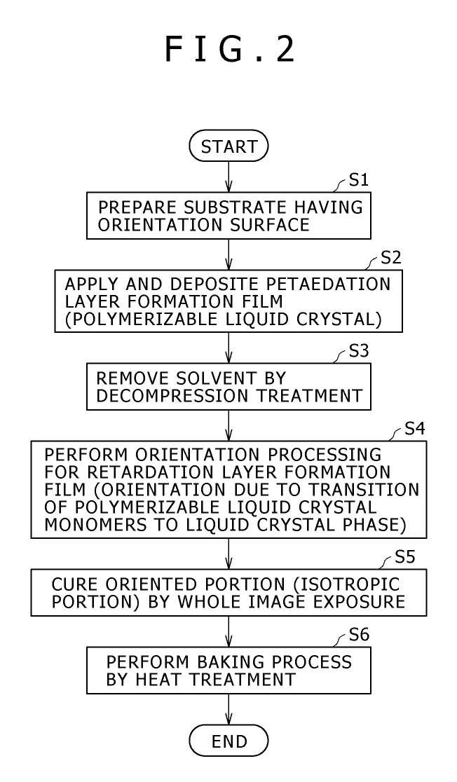

FIG. 2 is a flow chart showing a first example of a procedure of forming the retardation layer as described above. Hereinafter, the first example of a method of forming the retardation layer will be described in accordance with the flow chart shown in FIG. 2.

Firstly, in Step S1, there is prepared a substrate including an orientation surface having an orientation function. In this case, for example, an oriented film is formed on a glass substrate. The known method can be applied to the formation of the oriented film. An oriented film, made of polyimide, polyamide, polyvinyl alcohol or the like, which is used in a normal liquid crystal display device is used as the oriented film. A normal method is applied to rubbing processing for such an oriented film. The normal method is as follows. That is to say, a rubbing cloth, a material of which is selected from the group consisting of rayon, cotton, polyamide, polymethylmetaacrylate, and the like is wound on a metallic roll. Then, the metallic roll having the rubbing cloth wound thereon is rotated in a state of contacting a film, or the film is carried while the metallic roll is fixed, thereby rubbing a film surface with the rubbing cloth. It is noted that a support film which originally has the orientation function may be prepared as a substrate having the orientation surface.

Next, in Step S2, a retardation layer formation film is applied and deposited on the orientation surface of the substrate. A liquid solution (application liquid) containing therein the polymerizable liquid crystal monomers exemplified in Compounds (1) to (5) is applied and deposited on the orientation surface of the substrate by utilizing a spin coat method. However, it is supposed that 50% or more of the polymerizable liquid crystal monomers in the retardation layer formation film have two or more acrylate groups at their ends. As a result, the retardation layer after the polymerizable liquid crystal monomers are three-dimensionally cross-linked can be made to be excellent in heat resistance and in chemical resistance.

In addition, it is important in the application and deposition of the retardation layer formation film stated herein that the retardation layer formation film is applied and deposited on the orientation surface of the substrate to have a thickness corresponding to a design thickness of the retardation layer. In addition, the application liquid used in this case is conditioned by suitably dissolving an addition agent such as an interfacial active agent or a photopolymerization initiator in addition to any of the polymerizable liquid crystal monomers described above in a solvent. It is noted that the retardation finally obtained is made to have the inverse dispersibility by mixing the various addition agents laid open in WO2006/052001 or the like with one another.

An agent which is obtained by singularly using or mixing a plurality kind of acrylic interfacial active agent, silicon system interfacial active agent, and fluorine system interfacial active agent with one another can be used as the interfacial active agent described above. BYK361, BYK307, BYK325, BYK344, BYK352, BYK354, and BYK392 (names of products manufactured by BYK-Chemie Japan K.K.), and POLYFLOW461 (a name of a product manufactured by KYOEISHA CHEMICAL Co., LTD) can be given as the acrylic materials. SC101 and SC386 (names of products manufactured by AGC Co., Ltd.), Megafack R-08, Megafack R-90 and Megafack F-430 (names of products manufactured by Dainippon Ink & Chemicals, Incorporated) and DMAOP (a name of a product manufactured by AZmax Co., Ltd.) can be given as the fluorine system materials. Also, KF-643 and X22-1927 (names of products manufactured by Shin-Etsu Chemical Co., Ltd.), and the like can be given as the silicon system materials.

The interfacial active agent can be suitably added to the liquid crystal material so as to fall within the range that an amount of interfacial active agent added does not impede the orientation of the liquid crystal. In general, however, about 0.001 wt. % to about 10 wt. % interfacial active agent is preferably added to the liquid crystal material, and about 0.01 wt. % to about 5 wt. % interfacial active agent is more preferably added to the liquid crystal material.

Such an interfacial active agent is used to control a tilt angle of the polymerizable liquid crystal monomers in the optical element using the polymerizable liquid crystal composition of matter. Thus, it is possible to form the optical element in which the polymerizable liquid crystal monomers are oriented at the tilt angle at which inclined angles are uniform within the surface.

A thioxanthone system photopolymerization initiator (such as 2,4-diethylthioxanthone or 2-chlorothioxanthone), a benzophenone system photopolymerization initiator (such as benzophenone, or (4-(methylphenylthio)phenyl)phenylmethanone), or an anthraquinone system photopolymerization initiator (such as ethylanthraquinone) can be used as the photopolymerization initiator. In addition thereto, a commercially available photopolymerization initiator (such as Irgacure184, Irgacure369, Irgacure651, Irgacure819, Irgacure907, IrgacureOXE02, IrgacureOXE01, Darocur 1173 or Darocur 4265 manufactured by Ciba Japan K.K.) or the like can also be used the photopolymerization initiator. Also, two of them may also be blended as may be necessary. Also, any other suitable photopolymerization initiator and an auxiliary agent for a polymerization initiator may also be blended to be used. With regard to an addition amount, in general, 0.01 to 15 wt. % photopolymerization initiator can be added to the polymerizable liquid crystal monomer, 0.1 to 12 wt. % photopolymerization initiator can be preferably added to the polymerizable liquid crystal monomer. Also, 0.5 to 10 wt. % photopolymerization initiator can be more preferably added to the polymerizable liquid crystal monomer.

Next, in Step S3, the solvent in the retardation layer formation film is removed away by performing a decompression treatment.

After that, in Step S4, the orientation processing is performed for the retardation layer formation film. In this case, a heat treatment is carried out for the retardation layer formation film, which results in that the polymerizable liquid crystal monomers in the retardation layer formation film are made to transit to a liquid crystal phase, and thus oriented with respect to an orientation direction of the orientation surface of the base. Note that, it is important that the heat treatment in this process is carried out at low temperature ranging from the temperature at which the polymerizable liquid crystal monomers show the liquid crystal phase to the temperature at which the polymerizable liquid crystal monomers are not cross-linked. In addition, the polymerizable liquid crystal monomers are oriented with respect to the orientation direction of the orientation surface without carrying out the heat treatment depending on an orientation restraining force of the orientation surface in the substrate or a temperature at which the polymerizable liquid crystal monomers transit to the liquid crystal phase. Thus, the heat treatment may be carried out as may be necessary. Also, some polymerizable liquid crystal monomers can be oriented by carrying out a reduced-pressure drying treatment.

Next, in Step S5, whole image exposure is carried out for the retardation layer formation film, for which the orientation processing is previously performed, at room temperature or in a heating state. As a result, the polymerizable liquid crystal monomers contained in the retardation layer formation film are three-dimensionally cross-linked, and the retardation layer formation film is cured, thereby obtaining the retardation layer. Here, a mercury excitation light source such as a low-pressure mercury lamp, a high-pressure mercury lamp, or an ultrahigh-pressure mercury lamp, a xenon light source, or the like can be used as a light source for an exposure light (radiation). In particular, it is preferable to select the light source having an intensity peak in the wavelength band in which the photopolymerization initiator has the high sensitivity.

From the above, there is obtained the retardation layer in which a retardation R(450) for a wavelength of 450 nm, and a retardation R(550) for a wavelength of 550 nm fulfill a relationship of R(450)/R(550)≦1.

### <Method of Forming Retardation Layer—2>

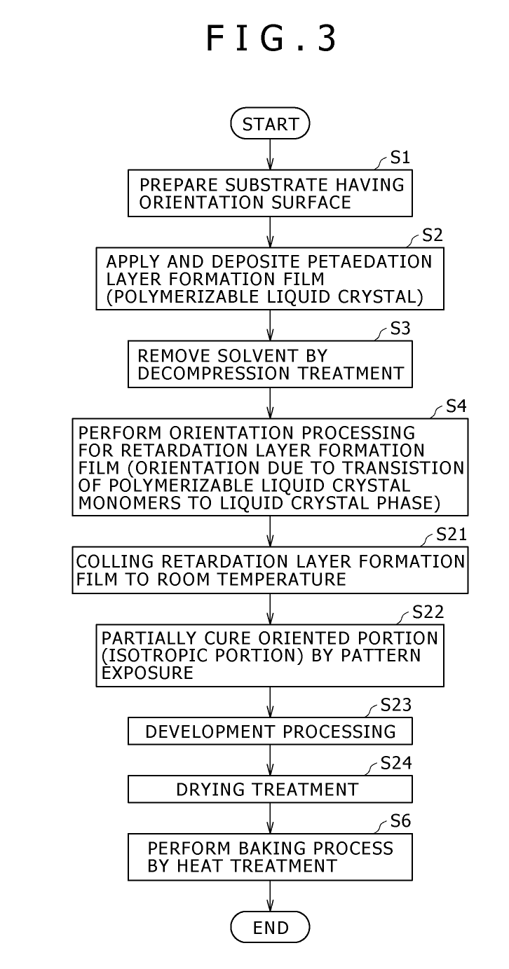

FIG. 3 is a flow chart showing a second example of a procedure for forming the retardation layer as described above. The second example of a method of forming the retardation layer patterned will be described hereinafter in accordance with the flow chart shown in FIG. 3.

Firstly, the processing from Step S1 to Step S4 is performed similarly to the case of the first example previously stated. Thus, the orientation processing is performed for the retardation layer formation film containing therein the polymerizable liquid crystal monomers exemplified as Compounds (1) to (5) by the heating.

After that, in Step S21, the retardation layer formation film is cooled to room temperature.

Next, in Step S22, pattern exposure is carried out for the retardation layer formation film through a photo mask or the like, thereby three-dimensionally cross-linking the polymerizable liquid crystal monomers only in an exposed portion. In addition, the mercury excitation light source such as the low-pressure mercury lamp, the high-pressure mercury lamp, or the ultrahigh-pressure mercury lamp, the xenon light source, or the like can be used as the light source for the exposure light (radiation) in this pattern exposure. In particular, it is preferable to select the light source having the intensity peak in the wavelength band in which the photopolymerization initiator has the high sensitivity.

Next, in Step S23, development processing is performed by using a developer in which the retardation layer formation film can be dissolved. Any suitable developer can be used as long as the retardation layer formation film can be dissolved therein. Thus, an inorganic alkali liquid solution, an organic alkali liquid solution, an organic solvent or the like is used as the developer in the development processing. As a result, the retardation layer is obtained by patterning the retardation layer formation film so as to leave only the portion in which the polymerizable liquid crystal monomers are three-dimensionally cross-linked by the pattern exposure in Step S22 previously stated. It is noted that cleaning processing using a rinse agent may be performed after completion of the development processing.

In addition, in Step S24, the developer and the rinse agent are both removed away by carrying out a drying treatment. In addition, a technique with which the unexposed portion is made to transit to an isotropic phase by adjusting the temperature, and is then cured by the light or the heat may also be used as another patterning technique.

After completion of the processing in Step S24, in Step S6, the retardation layer is cured by carrying out the heat treatment similarly to the case of the first example. In this case, the heat treatment is carried out at a heating temperature of 150 to 230° C. for a time period from about 10 minutes to about several hours.

From the above, there is obtained the retardation layer in which the retardation R(450) for the wavelength of 450 nm, and the retardation R(550) for the wavelength of 550 nm fulfill the relationship of R(450)/R(550)≦1. The resulting retardation layer is patterned in a shape on the substrate corresponding to the pattern exposure previously carried out in Step S22.

### <Liquid Crystal Display Device—1>

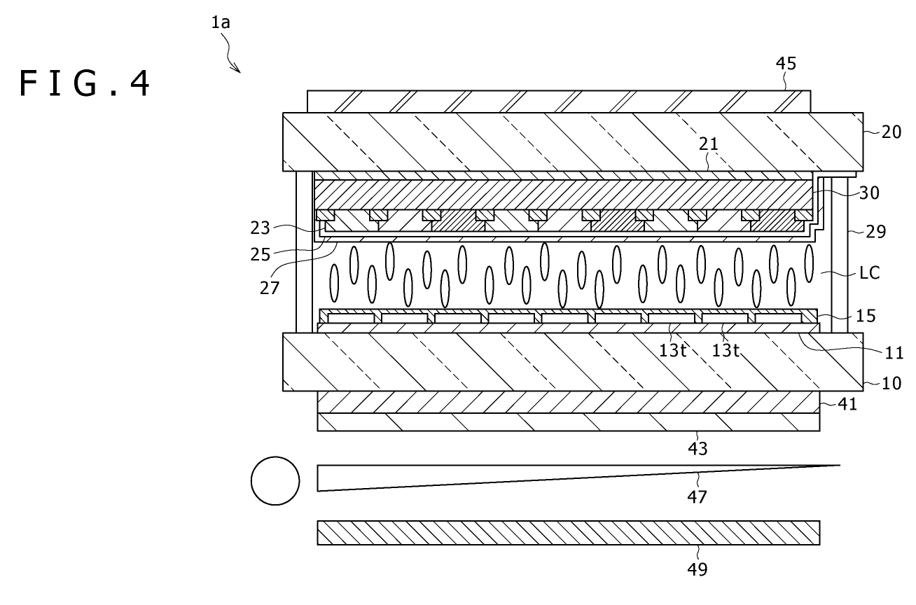

FIG. 4 is a cross sectional view showing a structure of a transmission type liquid crystal display device according to a first embodiment of the present invention. Hereinafter, a structure of a liquid crystal display device according to the first embodiment of the present invention with reference to FIG. 4.

A liquid crystal display device 1a shown in the figure is transmission type one, and a liquid crystal layer LC is sealed between a first substrate 10 and a second substrate 20 made of transparent materials, respectively. Also, a retardation layer 30 not having the normal dispersibility, but having the structure described above is provided on the liquid crystal layer LC side in the second substrate 20. In addition, a retardation plate 41 for compensating for a view angle for transmission display, and ensuring a transmittance is tightly provided on an outer surface of the first substrate 10. Furthermore, polarizing plates 43 and 45 are tightly provided on outer surfaces of the first substrate 10 and the second substrate 20, respectively, in a cross-Nicol manner. Also, a backlight 47 and a reflecting plate 49 are disposed in this order outside the polarizing plate 43 disposed on the first substrate 10 side.

Of them, the first substrate 10 is composed of a transparent substrate such as a glass substrate. A drive circuit layer 11 is provided on an inner surface of the first substrate 10 facing the liquid crystal layer LC. Here, in the drive circuit layer 11, a drive circuit, for example, using a Thin Film Transistor (TFT) or the like is covered with an insulating film. In addition, transparent pixel electrodes 13t are disposed and formed on the drive circuit layer 11, and an oriented film 15 is provided so as to cover these transparent pixel electrodes 13t.

On the other hand, the second substrate 20 is composed of a transparent substrate such as a glass substrate. An oriented film 21 as a base of the retardation layer 30 is provided on an inner surface of the second substrate 20 facing the liquid crystal layer LC. Also, the retardation layer 30 described above which is oriented along an orientation axis of the oriented film 21 is provided over the entire surface of a display region in the second substrate 20. A retardation of such a retardation layer 30 is suitably set in accordance with optical design set every display mode of the transmission type liquid crystal display device 1a. For example, the retardation of such a retardation layer 30 is set in the range of 50 to 400 nm as the retardation for a visible light (for example, having a wavelength of 550 nm). In addition, such a retardation layer 30 is formed by applying the manufacturing method previously described with reference to the flow chart of FIG. 2. In addition, an orientation axis (a phase delay axis or a phase advance axis of the retardation layer 30) of the oriented film 21 is also set in accordance with the optical design set every display mode of the liquid crystal display device 1a. For example, the orientation axis of the oriented film 21 is set in the range of 0 to 90° with respect to a transmission axis of the polarizing plate 45.

In addition, color filters corresponding to red (R), green (G) and blue (B), respectively, and a color filter layer 23 having a black matrix provided therein as may be necessary are provided on the retardation layer 30. Moreover, a common electrode 25 made of a transparent conductive material, and an oriented film 27 are provided in this order on the color filter layer 23. A rubbing treatment or orientation processing, for example, is carried out for the oriented film 27 in anti-parallel with the oriented film 15 provided on the first substrate 10 side.

It is noted that the liquid crystal layer LC is filled and sealed between the first substrate 10 and the second substrate 20 by using a sealant 29 provided in each of the peripheries of the first substrate 10 and the second substrate 20.

In the transmission type liquid crystal display device 1a structured in the manner described above, the retardation layer 30 is provided within the liquid crystal cell having the liquid crystal layer LC sealed between the first substrate 10 and the second substrate 20. In this case, the retardation layer 30 does not have the normal dispersibility, but has preferably the inverse dispersibility so as to fulfill the above retardation conditions. For this reason, the retardation layer 30 which is excellent in contrast and in appearance quality of display, and which responds to the broad wavelength band in spite of having the single layer structure is disposed in the liquid crystal cell. In addition, the retardation layer 30 is excellent in heat resistance and in chemical resistance because it has the structure in which the polymerizable liquid crystal monomers are three-dimensionally cross-linked.

As a result, the transmission type liquid crystal display device 1a described above is such that the reliable retardation layer 30 which has the broadband property in spite of having the single layer structure, and which is excellent in heat resistance and in chemical resistance is disposed in the liquid crystal cell. Therefore, it is possible to realize the simplification of the manufacturing processes, and the enhancement of the reliability.

It is noted that when the liquid crystal layer LC is made of the liquid crystal molecules having homeotropic alignment, the transmission type liquid crystal display device 1a is driven in a VA mode. Also, in such a VA mode type liquid crystal display device, the inverse wavelength dispersion type retardation layer 30 is provided in the transmissive portion. As a result, it is possible to provide the transmission type liquid crystal display device which is excellent in appearance quality of transmission display because of the enhancement of the transmittance, the improvement in contrast from an oblique direction, and the like. In addition, when the liquid crystal layer LC is made of the liquid crystal molecules having homogeneous alignment, the transmission type liquid crystal device 1a is driven either in an ECB mode or in a transverse electric field mode. Also, in such a transmission type liquid crystal display device 1a, the inverse wavelength dispersion type retardation layer 30 is provided in the transmissive portion. As a result, it is possible to provide the transmission type liquid crystal display device which is excellent in appearance quality as well of transmission display because of the enhancement of the transmittance, the improvement in contrast from the oblique direction, and the like.

### <Liquid Crystal Display Device—2>

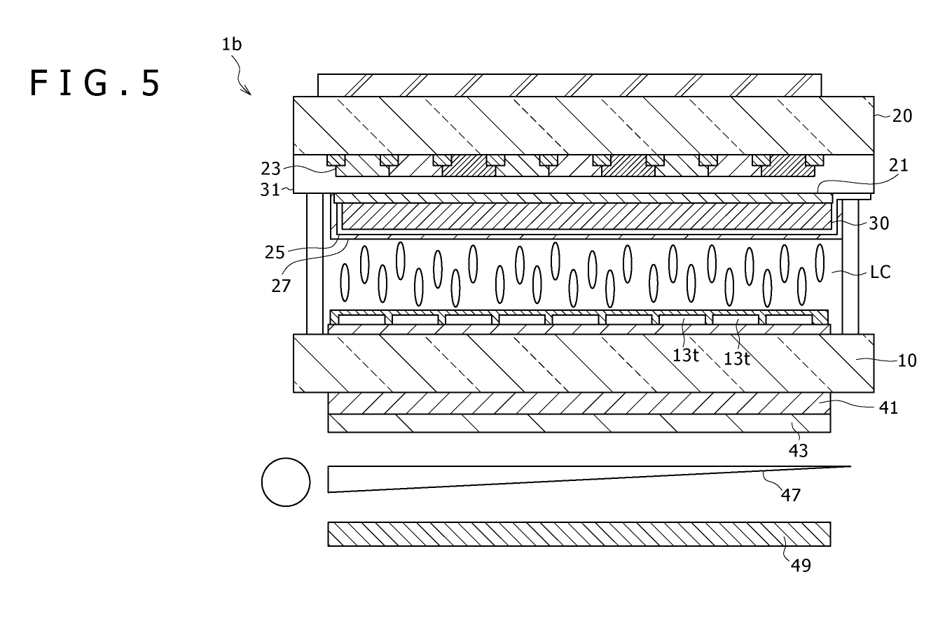

FIG. 5 is a cross sectional view showing a structure of a transmission type liquid crystal display device according to a second embodiment of the present invention. Hereinafter, a structure of the liquid crystal display device of the second embodiment will be described with reference to FIG. 5. It is noted that the same constituent elements as those previously described with reference to FIG. 4 are designated with the same reference numerals, respectively, and a repeated description is omitted here for the sake of simplicity.

A liquid crystal display device 1b shown in the figure is transmission type one. The transmission type liquid crystal display device 1b is different from the transmission type liquid crystal display device la previously described with reference to FIG. 4 in lamination order on the liquid crystal layer LC side of the second substrate 20. Other structures of the transmission type liquid crystal display device 1b are the same as those in the transmission type liquid crystal display device 1a.

That is to say, the color filter layer 23 is provided on the inner surface of the second substrate 20 facing the liquid crystal layer LC. Also, a protective insulating film 31 having a flat surface is provided so as to cover the color filter layer 23. Also, the retardation layer 30 which does not have the normal dispersibility, but has the structure described above is provided over the entire surface of the protective insulating film 31 through the oriented film 21. Also, the common electrode 25 and the oriented film 27 are provided in this order so as to cover the retardation layer 30. Note that, it is similar to the case of the first embodiment that the retardation of such a retardation layer 30 is suitably set in accordance with the optical design set every display mode of the transmission type liquid crystal display device 1a, and for example, the retardation of such a retardation layer 30 is set in the range of 50 to 400 nm as the retardation for the visible light (for example, having a wavelength of 550 nm). It is also similar to the case of the first embodiment that the orientation axis of the oriented film 21 is also set in accordance with the optical design set every display mode of the transmission type liquid crystal display device 1a, and for example, the orientation axis of the oriented film 21 is set in the range of 0 to 90° with respect to the transmission axis of the polarizing plate 45.

Even in the transmission type liquid crystal display device 1b of the second embodiment structured in the manner as described above, the retardation layer 30 which does not have the normal dispersibility, but has preferably the inverse dispersibility, and in which the polymerizable liquid crystal monomers are three-dimensionally cross-linked is provided within the liquid crystal cell having the liquid crystal layer LC sealed between the first substrate 10 and the second substrate 20. Therefore, it is possible to obtain the same effects as those of the first embodiment.

### <Liquid Crystal Display Device—3>

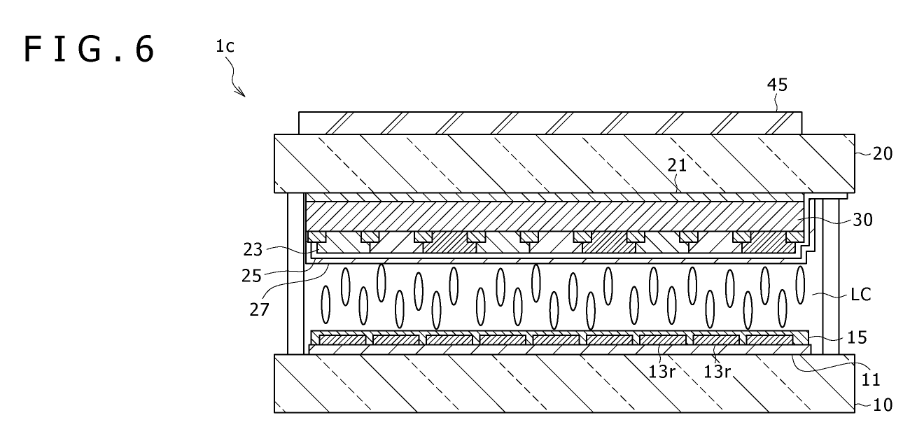

FIG. 6 is a cross sectional view showing a structure of a reflection type liquid crystal display device according to a third embodiment of the present invention. Hereinafter, a structure of the liquid crystal display device of the third embodiment will be described with reference to FIG. 6. It is noted that the same constituent elements as those previously described the first and second embodiments with reference to FIGS. 4 and 5 are designated with the same reference numerals, respectively, and a repeated description is omitted here for the sake of simplicity.

A liquid crystal display device 1c shown in the figure is reflection type one. Thus, the liquid crystal layer LC is sealed between the first substrate 10 and the second substrate 20 made of a transparent material. Also, the retardation layer 30 which does not have the normal dispersibility, but has the structure described above is provided over the entire surface of the oriented film 21, that is, on the liquid crystal layer LC side in the second substrate 20. In addition, the polarizing plate 45 is tightly provided only on the outer surface of the second substrate 20.

Of them, the drive circuit layer 11 is provided on the inner surface of the first substrate 10 facing the liquid crystal layer LC. Also, pixel electrodes 13r each serving as a reflective layer as well are disposed and formed on the upper surface of the drive circuit layer 11. The oriented film 15 is provided so as to cover these pixel electrodes 13r.

On the other hand, the structure on the second substrate 20 side is the same as that in the first embodiment. That is to say, the second substrate 20 is composed of the transparent substrate such as a glass substrate. The retardation layer 30 described above is provided over the entire surface of the second substrate 20 facing the liquid crystal layer LC through the oriented film 21. Moreover, the color filter 23, the common electrode 25, and the oriented film 27 are provided in this order on the second substrate 20 side. The rubbing treatment or the orientation processing, for example, is carried out for the oriented film 27, for example, in anti-parallel with the oriented film 15 provided on the first substrate 10 side. Note that, it is similar to the case of the first embodiment that the retardation of such a retardation layer 30 is suitably set in accordance with the optical design set every display mode of the transmission type liquid crystal display device 1c, and for example, the retardation of such a retardation layer 30 is set in the range of 50 to 400 nm as the retardation for the visible light (for example, having a wavelength of 550 nm). It is also similar to the case of the first embodiment that the orientation axis of the oriented film 21 is also set in accordance with the optical design set every display mode of the reflection type liquid crystal display device 1c, and for example, the orientation axis of the oriented film 21 is set in the range of 0 to 90° with respect to the transmission axis of the polarizing plate 45.

Even in the reflection type liquid crystal display device 1c of the third embodiment structured in the manner as described above, the retardation layer 30 which does not have the normal dispersibility, but has preferably the inverse dispersibility, and in which the polymerizable liquid crystal monomers are three-dimensionally cross-linked is provided within the liquid crystal cell having the liquid crystal layer LC sealed between the first substrate 10 and the second substrate 20. Therefore, it is possible to obtain the same effects as those of the first embodiment.

### <Liquid Crystal Display Device—4>

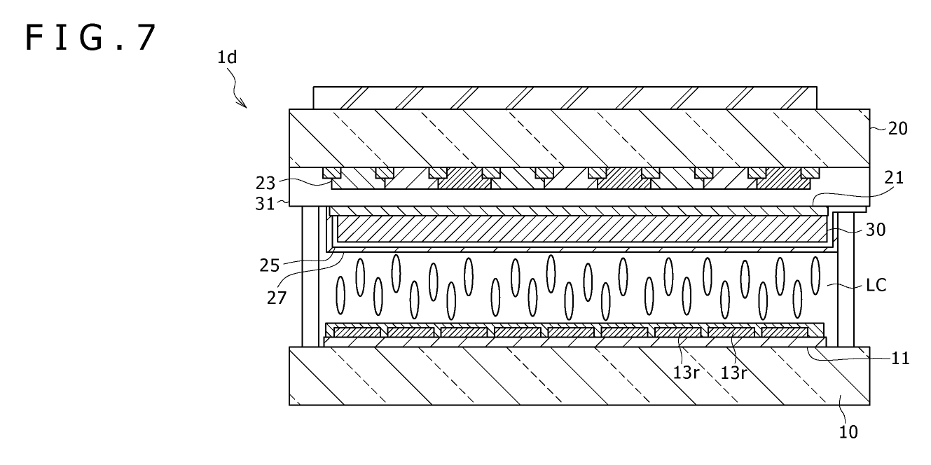

FIG. 7 is a cross sectional view showing a structure of a reflection type liquid crystal display device according to a fourth embodiment of the present invention. Hereinafter, a structure of the liquid crystal display device of the second embodiment will be described in each of with reference to FIG. 6. It is noted that the same constituent elements as those previously described in the first to third embodiments with reference to FIGS. 4 to 6 are designated with the same reference numerals, respectively, and a repeated description is omitted here for the sake of simplicity.

A liquid crystal display device 1d shown in the figure is reflection type one. The reflection type liquid crystal display device 1d is different from the reflection type liquid crystal display device 1c previously described with reference to FIG. 6 in lamination order on the liquid crystal layer LC side of the second substrate 20. Other structures of the reflection type liquid crystal display device 1d are the same as those in the reflection type liquid crystal display device 1c.

That is to say, the color filter layer 23 is provided on the inner surface of the second substrate 20 facing the liquid crystal layer LC. Also, the protective insulating film 31 having the flat surface is provided so as to cover the color filter layer 23. Also, the retardation layer 30 which does not have the normal dispersibility, but has the structure described above is provided over the entire surface of the protective insulating film 31 through the oriented film 21. Also, the common electrode 25 and the oriented film 27 are provided in this order so as to cover the retardation layer 30. Note that, it is similar to the case of the first embodiment that the retardation of such a retardation layer 30 is suitably set in accordance with the optical design set every display mode of the reflection type liquid crystal display device 1d, and for example, the retardation of such a retardation layer 30 is set in the range of 50 to 400 nm as the retardation for the visible light (for example, having the wavelength of 550 nm). It is also similar to the case of the first embodiment that the orientation axis of the oriented film 21 is also set in accordance with the optical design set every display mode of the reflection type liquid crystal display device 1d, and for example, the orientation axis of the oriented film 21 is set in the range of 0 to 90° with respect to the transmission axis of the polarizing plate 45.

Even in the reflection type liquid crystal display device 1d of the fourth embodiment structured in the manner as described above, the retardation layer 30 which does not have the normal dispersibility, but has preferably the inverse dispersibility, and in which the polymerizable liquid crystal monomers are three-dimensionally cross-linked is provided within the liquid crystal cell having the liquid crystal layer LC sealed between the first substrate 10 and the second substrate 20. Therefore, it is possible to obtain the same effects as those of the first embodiment.

### <Liquid Crystal Display Device—5>

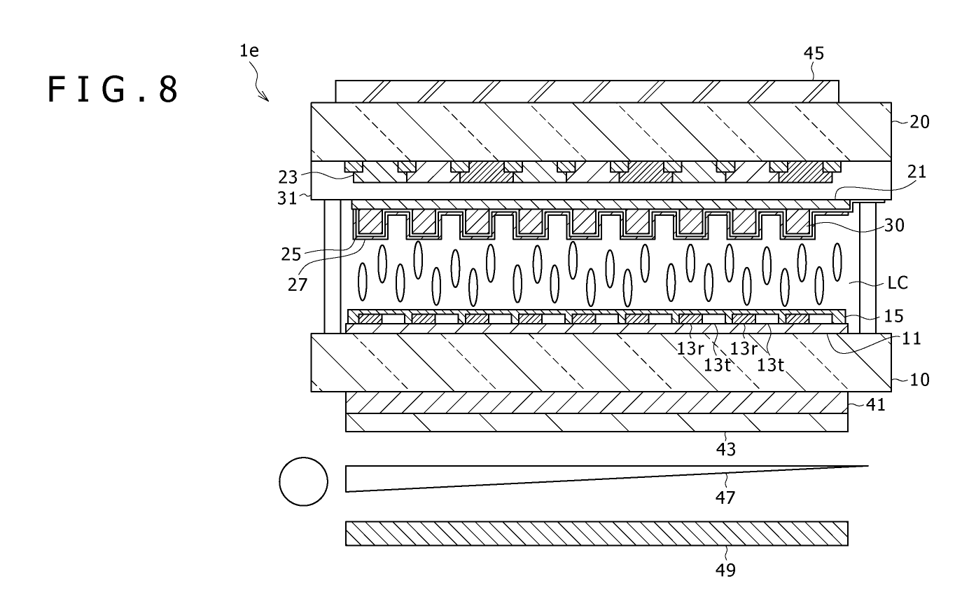

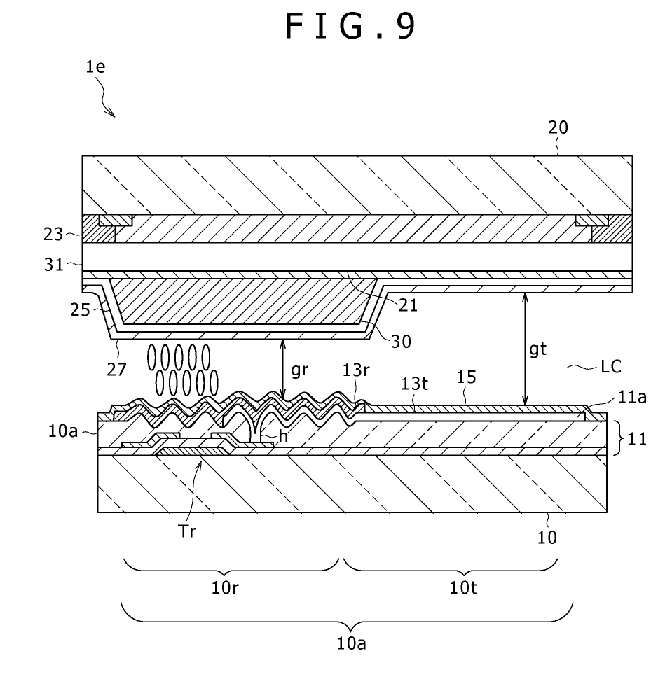

FIG. 8 is a cross sectional view showing a structure of a semitransmission and semireflection type liquid crystal display device according to a fifth embodiment of the present invention. FIG. 9 is a cross sectional view showing a structure of a main portion for one pixel of the semitransmission and semireflection type liquid crystal display device according to the fifth embodiment of the present invention. Hereinafter, a structure of the liquid crystal display device of the fifth embodiment will be described with reference to FIGS. 8 and 9. It is noted that the same constituent elements as those previously described the first to fourth embodiments with reference to FIGS. 4 to 7 are designated with the same reference numerals, respectively, and a repeated description is omitted here for the sake of simplicity.

A liquid crystal display device 1e shown in these figures is semitransmission and semireflection type one. The liquid crystal layer LC is sealed between the first substrate 10 and the second substrate 20 made of transparent materials, respectively. Also, the retardation layer 30 which does not have the normal dispersibility, but has the structure described above is provided on the liquid crystal layer LC side in the second substrate 20. In addition, the retardation plate 41 is tightly provided on the outer surface of the first substrate 10. Furthermore, the polarizing plates 43 and 45 are tightly provided on the outer surfaces of the first substrate 10 and the second substrate 20, respectively, in the cross-Nicol manner. In addition, the backlight 47 and the reflecting plate 49 are disposed in this order outside the polarizing plate 43 disposed on the first substrate 10 side.

The drive circuit layer 11 is provided on the inner surface of the first substrate 10 facing the liquid crystal layer LC. Pixel electrodes composed of the transparent pixel electrodes 13t and the reflective pixel electrodes 13r are disposed and formed in pixels 10a, respectively, on the drive circuit layer 11. In this case, in each of the pixels 10a, a portion in which the reflective pixel electrode 13r is disposed becomes a reflective display portion 10r, and a portion in which the transparent pixel electrode 13t is disposed becomes a transmissive display portion 10t.

In addition, as especially shown in FIG. 9, the reflective pixel electrode 13r is preferably structured in the form of a diffusion reflecting layer having an uneven shape on its surface. In this case, in the drive circuit layer 11 of the reflective display portion 10r as the base of the reflective pixel electrode 13r, the surface of an insulating film 11a covering the layer 11 of the drive circuit using the thin film transistor Tr is shaped into an uneven shape, and the reflective pixel electrode 13r is provided along the uneven shape. It is noted that the pixel electrode and the thin film transistor Tr are connected to each other by either the transparent pixel electrode 13t or the reflective pixel electrode 13r through a contact hole (connection hole) h formed in the insulating film 11a.

Also, the oriented film 15 is provided so as to cover the pixel electrodes composed of the transparent pixel electrodes 13t and the reflective pixel electrodes 13r used as the diffusion reflecting layer.

On the other hand, the color filter layer 23, the protective insulating film 31, the oriented film 21, and the retardation layer 30 which does not have the normal dispersibility, but has the structure described above are provided in this order on the inner surface of the second substrate 20 facing the liquid crystal layer LC. The retardation layer 30 is formed in a portion so as to correspond to the reflective pixel electrodes 13r (that is, the reflective display portions 10r) in the pixels. Also, the retardation layer 30 is formed by applying the manufacturing method previously described with reference to the flow chart of FIG. 3.

In addition, as especially shown in FIG. 9, a thickness (a cell gap gr) of the liquid crystal layer LC in the reflective display portion 10r, and a thickness (a cell gap gt) of the liquid crystal layer LC in the transmissive display portion 10t are both adjusted based on a thickness of the retardation layer 30. For example, the setting is performed for the cell gaps gr and gt in a way that while a suitable voltage is applied across the pixel electrode 13r or 13t and the common electrode 25, the liquid crystal layer LC has a retardation of λ/4 in the reflective display portion 10r, and has a retardation of λ/2 in the transmissive display portion 10t. In addition, the retardation layer 30 has the thickness described above. In addition, the retardation of the retardation layer 30 is suitably set in accordance with the optical design set every display mode of the reflective display portion 10r of the semitransmission and semireflection type liquid crystal display device 1e, and for example, the retardation of such a retardation layer 30 is set in the range of 50 to 400 nm as the retardation for the visible light (for example, having a wavelength of 550 nm). Also, the orientation axis of the oriented film 21 is also set in accordance with the optical design set every display mode of the semitransmission and semireflection type liquid crystal display device 1e, and for example, the orientation axis of the oriented film 21 is set in the range of 0 to 90° with respect to the transmission axis of the polarizing plate 45.

Also, the common electrode 25 and the oriented film 27 are provided in this order so as to cover the oriented film 21 and retardation layer 30 as described above.

Even in the semitransmission and semireflection type liquid crystal display device 1e of the fifth embodiment structured in the manner as described above, the retardation layer 30 which does not have the normal dispersibility, but has preferably the inverse dispersibility, and in which the polymerizable liquid crystal monomers are three-dimensionally cross-linked is provided within the liquid crystal cell having the liquid crystal layer LC sealed between the first substrate 10 and the second substrate 20. Therefore, it is possible to obtain the same effects as those of the first embodiment. In addition, the retardation layer 30 is formed in a pattern only in the reflective display portion 10r, which results in that it is possible to provide the semitransmission and semireflection type liquid crystal device 1e which is excellent in appearance quality for transmission display and in appearance quality for reflection display without exerting any of influences on the transmission display.

It is noted that the structure in which the pixel circuit using the thin film transistor Tr is disposed within the pixel 10a is shown in FIG. 9. In this case, an orientation imperfect portion, a light leakage portion and a non-display portion which are disposed in the vicinities of the pixel circuit (the thin film transistor Tr) are preferably shielded from the light. In addition, the pixel circuit is preferably disposed in the periphery of the pixel 10a.

### <Liquid Crystal Display Device—6 >

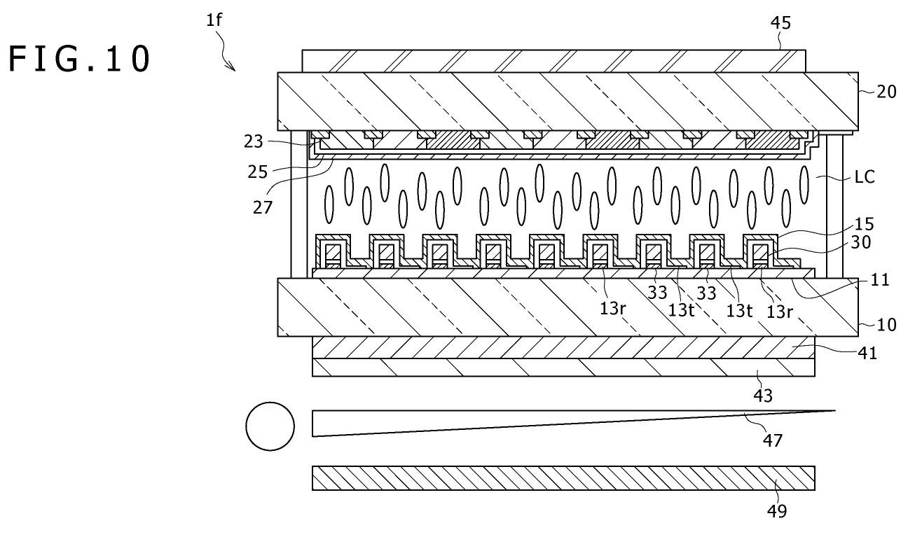

FIG. 10 is a cross sectional view showing a structure of a semitransmission and semireflection type liquid crystal display device according to a sixth embodiment of the present invention.

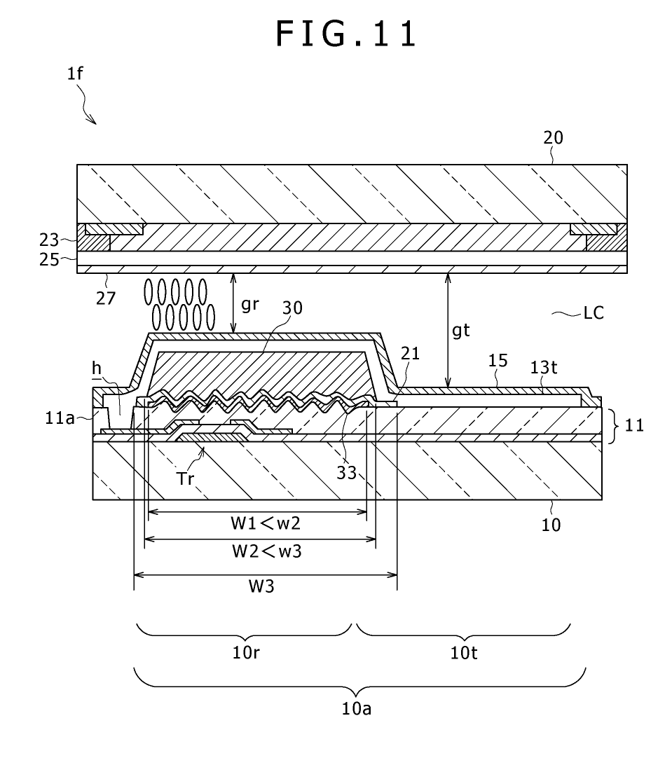

FIG. 11 is a cross sectional view showing a structure of a main portion for one pixel of the liquid crystal display device according to the sixth embodiment of the present invention. Hereinafter, a structure of the liquid crystal display device of the sixth embodiment will be described with reference to FIGS. 10 and 11. It is noted that the same constituent elements as those previously described in the first to fifth embodiments with reference to FIGS. 4 to 9 are designated with the same reference numerals, respectively, and a repeated description is omitted here for the sake of simplicity.

The liquid crystal display device if shown in these figures is semitransmission and semireflection type one. The semitransmission and semireflection type liquid crystal display device if of the sixth embodiment is different from the semitransmission and semireflection type liquid crystal display device 1e previously described with reference to FIGS. 8 and 9 in that the retardation layer 30 which does not have the normal dispersibility, but has the structure described above is formed in a pattern on the first substrate 10 side.

That is to say, the drive circuit layer 11 is provided on the inner surface of the first substrate 10 facing the liquid crystal layer LC. A reflective material layer 33 made of a metallic material such as aluminum (Al) or silver (Ag), an alloy thereof, or the like is formed in a pattern in the reflective display portion 10r in each of the pixels 10a on the drive circuit layer 11. Also, as especially shown in FIG. 11, the reflective pixel electrode 33 is preferably structured in the form of the diffusion reflecting layer having the uneven shape on its surface in the reflective display portion 10r. In this case, in the drive circuit layer 11 of the reflective display portion 10r as the base of the reflective material layer 33, the surface of the insulating film 11a covering the layer 11 of the drive circuit using the thin film transistor Tr is shaped into the uneven shape, and the reflective material layer 33 is provided along the uneven shape.

Also, the oriented film 21 as the base of the retardation layer 30 is provided so as to cover these reflective material layers 33. The retardation layer 30 described above which is isotropically oriented with respect to the oriented film 21 is formed in a pattern on the upper surface of the oriented film 21. The retardation layer 30 is formed in a pattern so as to correspond to the reflective display portions 10r in the pixels. Also, the retardation layer 30 is formed by applying the manufacturing method previously described with reference to the flow chart of FIG. 3. When the retardation layer using the oriented film is disposed on the drive circuit layer, it is preferable that in order to obtain conduction with the lower layer, either the oriented film is also previously patterned, or is removed away after formation of the retardation layer 30 by performing the development, the dry etching or the like.

In this case, it is important that a width, W1, of the reflective material layer 33, and a width, W2, of the retardation layer 30 are set so that the reflective material layer 33 is entirely covered with the retardation layer 30. For this reason, it is preferable that a relationship of the width, W1, of the reflective material layer 33<the width, W2, of the retardation layer 30, and a relationship of the width, W1, of the reflective material layer 33<the width, W2, of the retardation layer 30 are both established. In addition, when the oriented film as the base of the retardation layer 30 is patterned as shown in the figures, it is preferable that a relationship of the width, W2, of the retardation layer 30<a width, W3, of the oriented film 21, and a relationship of the width, W2, of the retardation layer 30<the width, W3, of the oriented film 21 are both established so that the retardation layer 30 is formed in a predetermined position.

In addition, the thickness (the cell gap gr) of the liquid crystal layer LC in the reflective display portion 10r, and the thickness (the cell gap gt) of the liquid crystal layer LC in the transmissive display portion 10t are both adjusted based on the thickness of the retardation layer 30. For example, the setting is performed for the cell gaps gr and gt in a way that while the suitable voltage is applied across the pixel electrode 13r or 13t and the common electrode 25, the liquid crystal layer LC has the retardation of λ/4 in the reflective display portion 10r, and has the retardation of λ/2 in the transmissive display portion 10t. In addition, the retardation layer 30 has the thickness described above. In addition, the retardation of the retardation layer 30 is suitably set in accordance with the optical design set every display mode of the reflective display portion 10r of the semitransmission and semireflection type liquid crystal display device if, and for example, the retardation of such a retardation layer 30 is set in the range of 50 to 400 nm as the retardation for the visible light (for example, having a wavelength of 550 nm). Also, the orientation axis of the oriented film 21 is also set in accordance with the optical design set every display mode of the semitransmission and semireflection type liquid crystal display device if, and for example, the orientation axis of the oriented film 21 is set in the range of 0 to 90° with respect to the transmission axis of the polarizing plate 45. These respects of the sixth embodiment are similar to those of the fifth embodiment.

The transparent pixel electrode 13t is formed in a pattern in each of the pixels 10a so as to be common to the reflective display portion 10r and the transmissive display portion 10t and so as to cover the oriented film 21 and the retardation layer 30 as described above. The transparent pixel electrode 13t is connected to the thin film transistor Tr through the contact hole (connection hole) h formed in the insulating film 11a covering the drive circuit. The contact hole h is disposed on one side of the retardation layer 30. As a result, the reflective material layer 33 featuring that it is entirely covered with the retardation layer 30 as described above is prevented from being exposed to an inner wall of the contact hole h. For this reason, for example, the metallic material of which the reflective material layer 33 is made is prevented from changing in quality in the post-process such as the dry etching process when the contact hole h is formed. Therefore, the reflection characteristics can be prevented from being deteriorated due to the change of properties of the reflective material layer 33. As a result, it is possible to maintain the reflection characteristics in the reflective material layer 33.

Also, the oriented film 15 is provided so as to cover the transparent pixel electrode 13t provided on the retardation layer 30 in the manner as described above.

On the other hand, the color filter layer 23, the common electrode 25 and the oriented film 27 are provided in this order on the inner surface of the second substrate 20 facing the liquid crystal layer LC.

Even in the semitransmission and semireflection type liquid crystal display device if of the sixth embodiment structured in the manner as described above, the retardation layer 30 which does not have the normal dispersibility, but has preferably the inverse dispersibility, and in which the polymerizable liquid crystal monomers are three-dimensionally cross-linked is provided within the liquid crystal cell having the liquid crystal layer LC sealed between the first substrate 10 and the second substrate 20. Therefore, it is possible to obtain the same effects as those of the first embodiment. In addition, the retardation layer 30 is formed in a pattern only in the reflective display portion 10r, which results in that it is possible to provide the semitransmission and semireflection type liquid crystal device if which is excellent in appearance quality for transmission display and in appearance quality for reflection display without exerting any of influences on the transmission display.

It is noted that the structure in which the pixel circuit using the thin film transistor Tr is disposed within the pixel 10a is shown in FIG. 11. In this case, the portion in which the pixel circuit (including the thin film transistor Tr) is formed is preferably shielded from the light. In addition, the pixel circuit is preferably disposed in the periphery of the pixel 10a.

### <Circuit Configuration of Liquid Crystal Display Device>

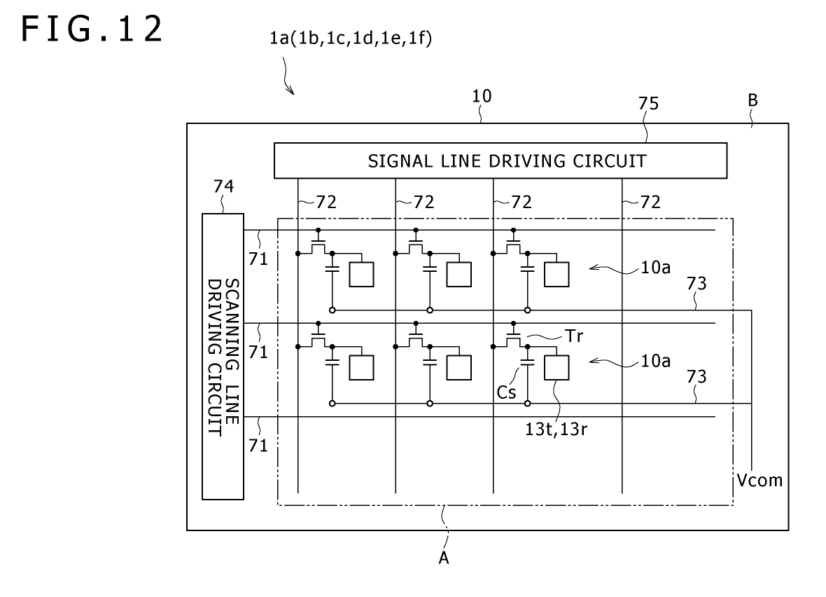

FIG. 12 is a circuit diagram, partly in block, showing a circuit configuration of the active matrix drive type liquid crystal display device 1a (1b, 1c, 1d, 1e, 1f) to which the embodiments of the present invention is applied. It is noted that the same constituent elements as those in each of the first to sixth embodiments described above are designated with the same reference numerals, respectively, and in this state, a description will now be given.

As shown in the figure, a display region A and its peripheral region B are provided in the liquid crystal display device 1a (1b, 1c, 1d, 1e, 1f). A plurality of scanning lines 71 and a plurality of signal lines 72 are wired horizontally and vertically, respectively. Also, pixels 10a are provided so as to correspond to intersection portions defined between the plurality of scanning lines 71 and the plurality of signal lines 72, respectively. A pixel array portion is structured in such a manner. In addition, common electrodes 73 each of which is common to the corresponding ones of the pixels 10a in the horizontal direction are provided in the display portion A. On the other hand, a scanning line driving circuit 74 and a signal line driving circuit 75 are disposed in the peripheral region B. In this case, the scanning line driving circuit 74 scans and drives the plurality of scanning lines 71. Also, the signal line driving circuit 75 supplies a video signal (that is, an input signal) corresponding to luminance information to the plurality of signal lines 72.

A pixel circuit, for example, is composed of the thin film transistor Tr serving as a switching element, and a hold capacitor Cs is provided in each of the pixels 1a. In addition, the pixel electrode 13r, 13t connected to the corresponding one of the pixel circuits is provided in each of the pixels 1a. Also, the hold capacitor Cs is defined between the corresponding one of the common electrodes 73, and the pixel electrode 13r, 13t. A gate of the thin film transistor Tr is connected to the corresponding one of the scanning lines 71, one of source/drain regions thereof is connected to the corresponding one of the signal lines 72, and the other thereof is connected to the corresponding one of the pixel electrodes 13r, 13t.

Also, the video signal written from the corresponding one of the signal lines 72 to the pixel 10a through the thin film transistor Tr is held in the hold capacitor Cs. A voltage corresponding to an amount of signal held is supplied to the pixel electrode 13r, 13t.

The configuration of the pixel circuit as descried above is merely an example. Thus, the pixel circuit may be configured by providing a capacitor element in the pixel circuit as may be necessary, and by providing therein a plurality of transistors. In addition, a necessary drive circuit may also be added to the peripheral region B in correspondence to change of the pixel circuit.

### EXAMPLES OF APPLICATION

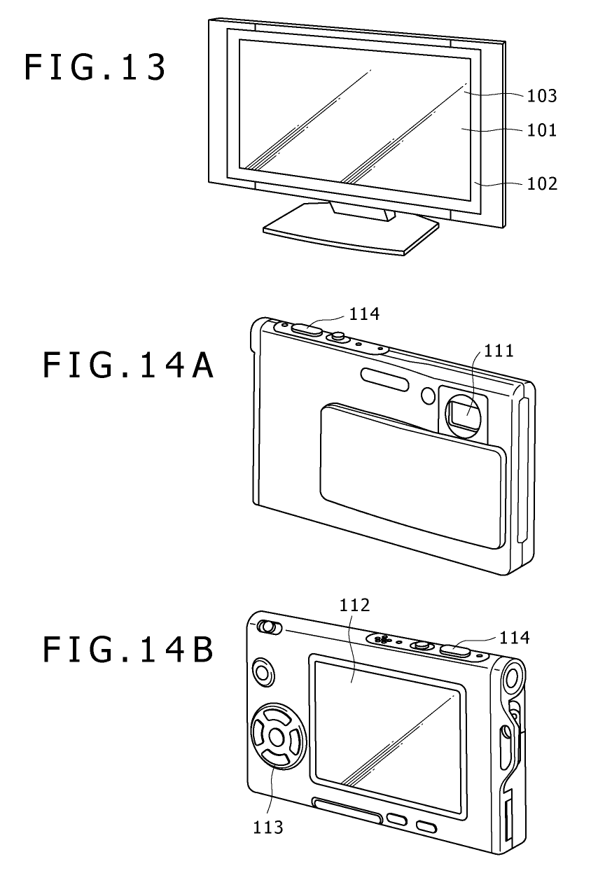

The display devices, described above, according to an embodiment of the present invention can be applied to display devices, of electronic apparatuses in all the fields, in each of which a video signal inputted to the electronic apparatus, or a video signal generated in the electronic apparatus is displayed in the form of an image or a video image. These electronic apparatuses are typified by various electronic apparatuses, shown in FIG. 13 to FIG. 17G, such as a digital camera, a notebook-size personal computer, mobile terminal equipment such as a mobile phone, and a video cameras. Hereinafter, examples of electronic apparatuses to each of which an embodiment of the present invention is applied will be described.

FIG. 13 is a perspective view showing a television set to which an embodiment of the present invention is applied. The television set according to this example of application includes an image display screen portion 101 composed of a front panel 102, a filter glass 103, and the like. Also, the television set is manufactured by using the display device according to an embodiment of the present invention as the image display screen portion 101.

FIGS. 14A and 14B are respectively perspective views showing a digital camera to which an embodiment of the present invention is applied. FIG. 14A is a perspective view when the digital camera is viewed from a front side, and FIG. 14B is a perspective view when the digital camera is viewed from a back side. The digital camera according to this example of application includes a light emitting portion 111 for flash, a display portion 112, a menu switch 113, a shutter button 114, and the like. The digital camera is manufactured by using the display device according to an embodiment of the present invention as the display portion 112.

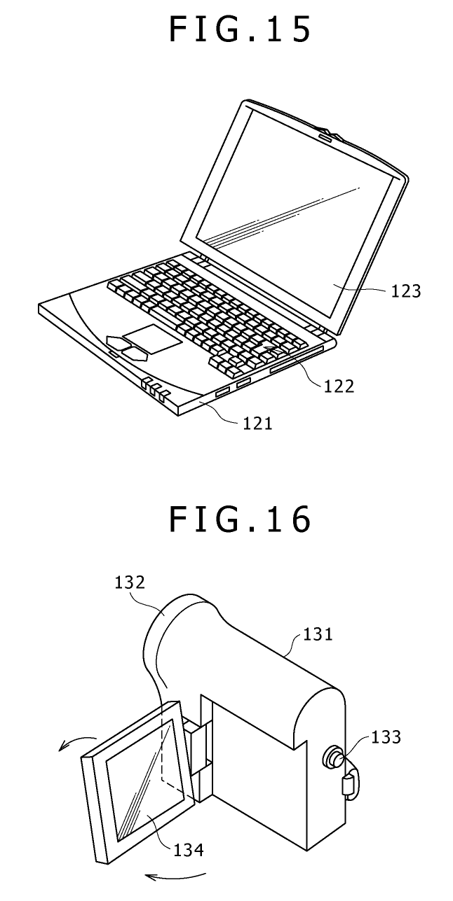

FIG. 15 is a perspective view showing a notebook-size personal computer to which an embodiment of the present invention is applied. The notebook-size personal computer according to this example of application includes a main body 121, a keyboard 122 which is manufactured when characters or the like are inputted, a display portion 123 for displaying thereon an image, and the like. The notebook-size personal computer is manufactured by using the display device according to an embodiment of the present invention as the display portion 123.

FIG. 16 is a perspective view showing a video camera to which an embodiment of the present invention is applied. The video camera according to this example of application includes a main body portion 131, a lens 132 which captures an image of a subject and which is provided on a side surface directed forward, a start/stop switch 133 which is manipulated when an image of a subject is captured, a display portion 134, and the like. The video camera is manufactured by using the display device according to an embodiment of the present invention as the display portion 134.

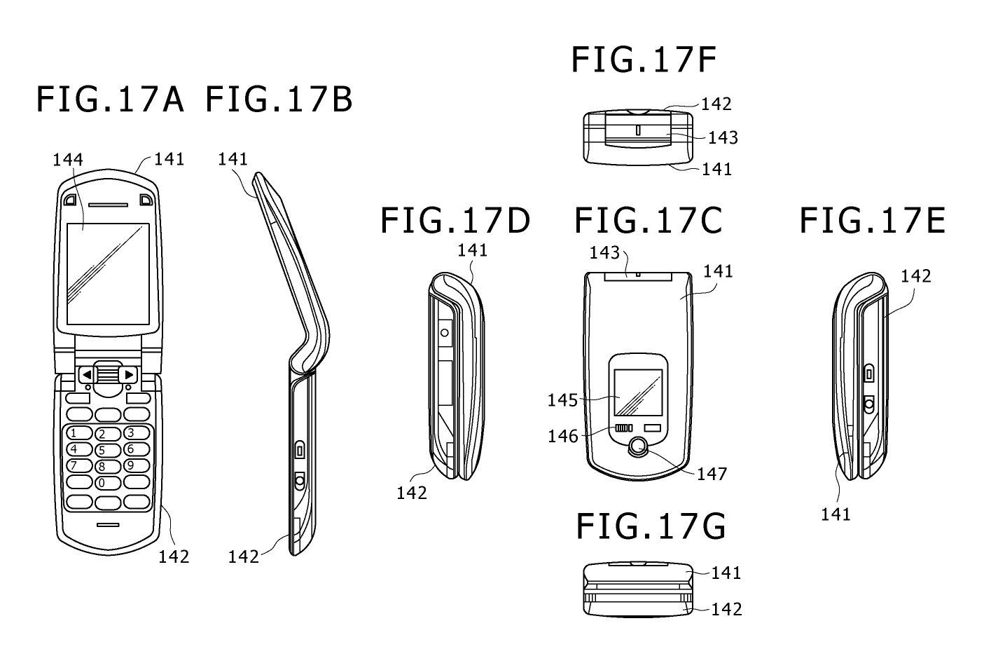

FIGS. 17A to 17G are respectively views showing mobile terminal equipment, for example, a mobile phone to which an embodiment of the present invention is applied. FIG. 17A is a front view in an open state of the mobile phone, FIG. 17B is a side elevational view in the open state of the mobile phone, FIG. 17C is a front view in a close state of the mobile phone, FIG. 17D is a left side elevational view of the mobile phone, FIG. 17E is a right side elevational view of the mobile phone, FIG. 17F is a top plan view of the mobile phone, and FIG. 17G is a bottom view of the mobile phone. The mobile phone according to this example of application includes an upper chassis 141, a lower chassis 142, a connection portion (a hinge portion in this case) 143, a display portion 144, a sub-display portion 145, a picture light 146, a camera 147, and the like. The mobile phone is manufactured by using the display device according to an embodiment of the present invention as the display portion 144 or the sub-display portion 145.

### EXAMPLES

### Example 1

A composition A is conditioned as the application liquid.

### Composition A

polymerizable liquid crystal monomer [Compound (1)]: 10 pts.wt.

polymerizable compound [Compound (6): 10 pts.wt.

polymerizable initiator [Irgacure OXE02]: 0.2 pts.wt.

interfacial active agent [MegafackR-08]: 0.02 pts.wt.

solvent [cyclohexanone]: 78.98 pts.wt.

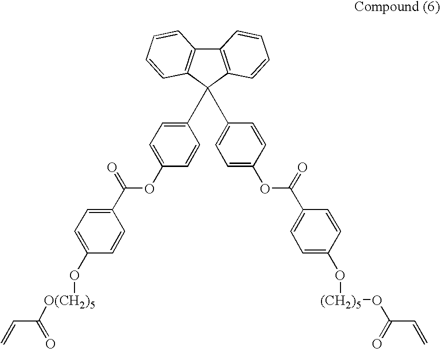

The compound A conditioned in the manner as described above was applied onto an oriented film AL1254 (a name of a product manufactured by JSR Corporation) for which the rubbing processing was previously performed by utilizing the spin coat method. After that, the solvent was removed away by carrying out the reduced-pressure drying treatment (a final ultimate vacuum of 0.4 Torr). Also, the orientation processing was performed at 60° C. for one minute by the heating on a hot plate. After that, the three-dimensional cross linking processing was performed in nitrogen ambient atmosphere (an oxygen concentration of 0.1% or less) under conditions that an illuminance was 30 mW/cm², and an exposure time was ten seconds by using the ultrahigh-pressure mercury lamp. Thereafter, a heat treatment was carried out at 220° C. for 60 minutes by using an oven.

When the thickness of the retardation layer produced in the manner as described above was measured by using a stylus-type profilometer, it was proved to be 1.1 μm. In addition, when the retardation was measured for the retardation layer at the front, it was 115 nm for the wavelength, λ, of 450 nm, and was 135 nm for the wavelength, λ, of 550 nm. As a result, it was confirmed that the retardation layer had the inverse wavelength dispersibility.

A reflection type liquid crystal display device (a VA mode and normally black) was manufactured in which the retardation layer thus obtained was disposed in each of the liquid crystal cells. In the reflection type liquid crystal display device, a reflectivity for black display was 0.2%, a reflectivity for white display was 5%, and a contrast was 25.

### Comparative Example 1

A liquid crystal display device was manufactured which had the same structure as that of Example 1 except that only the retardation layer having the inverse dispersibility was replaced with one having the normal dispersibility. The wavelength dispersion of the retardation layer used herein was 145 nm for the wavelength, λ, of 450 nm, and was 135 nm for the wavelength, λ, of 550 nm. In the liquid crystal display device manufactured in the manner as described above, a reflectivity for black display was 0.5%, a reflectivity for white display was 5%, and a contrast was 10.

It was confirmed from the results of comparison of Example 1 with Comparative Example 1 that the sufficient contrast was obtained in the liquid crystal display device using the retardation layer having the inverse dispersibility of Example 1.

### Example 2

A composition B is conditioned as the application liquid.

### Composition B

polymerizable liquid crystal monomer [Compound (1)]: 10 pts.wt.

polymerizable compound [Compound (6): 10 pts.wt.

polymerizable initiator [Irgacure OXE02]: 0.07 pts.wt.

interfacial active agent [Megafack R-08]: 0.02 pts.wt.

solvent [cyclohexanone]: 78.91 pts.wt.

The compound B conditioned in the manner as described above was applied onto an oriented film AL1254 (a name of a product manufactured by JSR Corporation) for which the rubbing processing was previously performed by utilizing the spin coat method. After that, the solvent was removed away by carrying out the reduced-pressure drying treatment (a final ultimate vacuum of 0.4 Torr). Also, the orientation processing was performed at 60° C. for one minute by the heating on a hot plate. Next, after the substrate was rapidly cooled to room temperature (25° C.), the three-dimensional cross-linking processing by the pattern exposure was performed in air through a photo mask with a pattern under conditions that an illuminance was 30 mW/cm², and an exposure time was two seconds by using the ultrahigh-pressure mercury lamp. Next, a methyl ethyl ketone liquid was sprayed to the substrate thus exposed at room temperature (25° C.) for 60 seconds by using a diffusion spray, thereby removing away the unexposed portion on the surface of the substrate. In such a manner, development processing was performed. After that, a heat treatment was carried out at 220° C. for 60 minutes by using an oven.

When the surface of the substrate after the retardation layer was formed in the manner as described above by using a microscope, it was confirmed that the pattern of the retardation layer was formed only on the exposed portion on the surface of the substrate. When the thickness of the retardation layer formed in the manner as described above was measured by using the stylus-type profilometer, it was proved to be 1.1 μm. In addition, when the retardation was measured for the retardation layer thus formed in a pattern at the front, it was 115 nm for the wavelength, λ, of 450 nm, and was 135 nm for the wavelength, λ, of 550 nm. As a result, it was confirmed that the retardation layer having the inverse wavelength dispersibility was formed in a pattern.

A semitransmission and semireflection type liquid crystal display device (the VA mode, normally black, and disposition of the reflective layer only in the pattern portion of the retardation layer) was manufactured in which the retardation layer thus obtained was disposed in each of the liquid crystal cells. In the semitransmission and semireflection type liquid crystal display device, a reflectivity for black display was 0.1%, a reflectivity for white display was 2.5%, and a contrast was 25.

### Comparative Example 2

A liquid crystal display device was manufactured which had the same structure as that of Example 2 except that only the retardation layer having the inverse dispersibility was replaced with one having the normal dispersibility. The wavelength dispersion of the retardation layer used herein was 145 nm for the wavelength, λ, of 450 nm, and was 135 nm for the wavelength, λ, of 550 nm. In the semitransmission and semireflection type liquid crystal display device manufactured in the manner as described above, a reflectivity for black display was 0.25%, a reflectivity for white display was 2.5%, and a contrast was 10.

It was confirmed from the results of comparison of Example 2 with Comparative Example 2 that the sufficient contrast was obtained in the liquid crystal display device using the retardation layer having the inverse dispersibility of Example 2.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display device including:
two sheets of substrates;
a liquid crystal layer sealed between said two sheets of substrates; and
a retardation layer provided on said liquid crystal layer side in one of said two sheets of substrates, wherein said retardation layer has a structure in which polymerizable liquid crystal monomers are three-dimensionally cross-linked, and a retardation R(450) for a wavelength of 450 nm and a retardation R(550) for a wavelength of 550 nm fulfill a relationship of R(450)/R(550)≦1.

2. The liquid crystal display device according to claim 1, wherein
a plurality of pixels each having a transmissive display portion and a reflective display portion set therein are disposed and formed between said two sheets of substrates; and
said retardation layer is formed in a pattern in each of said pixels so as to correspond to said reflective display portion.

3. A method of manufacturing a liquid crystal display device including the steps of
forming a retardation layer on a first substrate;
disposing a second substrate so as to face a side of a formation surface of said retardation layer in said first substrate; and
filling and sealing a liquid crystal layer between said first substrate and said second substrate, said method of manufacturing a liquid crystal display device, when said retardation layer is formed; comprising the steps of:
applying a liquid solution containing therein polymerizable liquid crystal monomers onto an orientation surface of said first substrate to form a retardation layer formation film;
performing orientation processing for said retardation layer formation film;
three-dimensionally cross-linking said polymerizable liquid crystal monomers contained said retardation layer formation film for which the orientation processing is performed to cure said polymerizable liquid crystal monomers; and
obtaining said retardation layer in which a retardation R(450) for a wavelength of 450 nm and a retardation R(550) for a wavelength of 550 nm fulfill a relationship of R(450)/R(550)≦1.

4. The method of manufacturing a liquid crystal display device according to claim 3, wherein 50% or more of said polymerizable liquid crystal monomers in said retardation layer formation film have two or more acrylate groups at their ends.

5. The method of manufacturing a liquid crystal display device according to claim 3, wherein in the three-dimensionally cross-linking of said polymerizable liquid crystal monomers, said polymerizable liquid crystal monomers are three-dimensionally cross-linked in an exposed portion by carrying out pattern exposure for said retardation layer formation film; and
said manufacturing method further comprises the step of:
pattering said retardation layer formation film so as to leave said exposed portion by performing development processing for said retardation layer formation film.

6. A liquid crystal display device including:
two sheets of substrates;
a liquid crystal layer sealed between said two sheets of substrates;
a reflective material layer provided on a side of said liquid crystal layer in one of said two sheets of substrates; and
a retardation layer formed in a pattern above said reflective material layer,
wherein said reflective material layer is entirely covered with said retardation layer.

7. The liquid crystal display device according to claim 6, wherein
a plurality of pixels each having a transmissive display portion and a reflective display portion set therein are disposed and formed between said two sheets of substrates; and
said reflective material layer and said retardation layer are each formed in a pattern in each of said pixels so as to correspond to said reflective display portion.

8. The liquid crystal display device according to claim 6, wherein said reflective material layer is made of a metallic material.
